(19) United States
(12) Patent Application Publication
(10) Pub. No.: US 2022/0146855 A1
(43) Pub. Date: May 12, 2022

(54) DISPLAY DEVICE, CONTACTLESS SWITCH, AND ELECTRONIC DEVICE

(71) Applicant: OMRON Corporation, Kyoto-shi, KYOTO (JP)

(72) Inventor: Yasuhiro TANOUE, Kyoto-shi (JP)

(73) Assignee: OMRON Corporation, Kyoto-shi, KYOTO (JP)

(21) Appl. No.: 17/430,740

(22) PCT Filed: Mar. 5, 2020
(86) PCT No.: PCT/JP2020/009441

§ 371 Date: Aug. 13, 2021

(30) Foreign Application Priority Data
Mar. 6, 2019 (JP) 2019-040929

(51) Int. Cl. G02B 30/56; F21V 8/00; G06F 3/041

(52) U.S. Cl. CPC G02B 30/56; G02B 6/006; G06F 2203/04108; G06F 3/041; G02B 6/0036

(57) ABSTRACT

The display device includes, on a back surface of a light guide plate, a first optical path alteration part group that forms a first image and a second optical path alteration part group that forms a second image, and a difference between an inclination angle of the first optical path alteration part group and an inclination angle of the second optical path alteration part group is equal to or greater than 10°.

### TECHNICAL FIELD

The present invention relates to a display device that forms an image in the air.

### BACKGROUND ART

Patent Document 1 discloses an optical device (display device) that forms a stereoscopic image. The optical device includes a light guide plate and a light converging part that causes outgoing light to exit from an outgoing surface in a direction in which light guided by the light guide plate substantially converges to or diverges from one convergence point or line in the air.

### PRIOR ART DOCUMENT

### Patent Document

Patent Document 1: Japanese Unexamined Patent Publication No. 2016-114929 (published on Jun. 23, 2016)

### SUMMARY OF THE INVENTION

### Problems to be Solved by the Invention

The display device disclosed in Patent Document 1 is, however, narrow in viewing angle at which a user can visually recognize a formed image in a direction parallel to the light guided in the light guide plate (hereinafter, referred to as a longitudinal direction).

For example, when the outgoing surface of the light guide plate is parallel to the vertical direction, and a center of the viewing angle is designed to be 30° with respect to the front surface of the display device, the image viewing angle falls within 30°±20°, that is, in a range of about 10° to 50°. When the viewpoint falls out of this range, the user cannot visually recognize the image.

It is therefore an object of an aspect of the present invention to provide a display device or the like having a viewing angle widened in a longitudinal direction.

### Means for Solving the Problem

In order to solve the above-described problems, provided according to an aspect of the present invention is a display device including a light source, and a light guide plate configured to form a first image and a second image in the air by guiding light incident from the light source and altering an optical path of the light guided to cause the light to exit from an outgoing surface. The light guide plate includes, on a back surface opposite to the light exit surface, a first optical path alteration part group configured to alter the optical path of the light to form the first image and a second optical path alteration part group configured to alter the optical path of the light to form the second image, and a difference between an inclination angle, with respect to the back surface, of a reflective surface of the first optical path alteration part group configured to alter the optical path of the light and an inclination angle, with respect to the back surface, of a reflective surface of the second optical path alteration part group configured to alter the optical path of the light is equal to or greater than 10°.

### Effect of the Invention

According to the aspect of the present invention, it is possible to provide a display device or the like having a viewing angle widened in the longitudinal direction.

### BRIEF DESCRIPTION OF THE DRAWINGS

FIG. 1 is a cross-sectional view of optical path alteration parts belonging to a first optical path alteration part group and a second optical path alteration part group, taken along a plane orthogonal to a reflective surface.

FIG. 2 is a diagram showing an example of a structure of a display device according to an embodiment.

FIG. 3 is a diagram showing an example of an image formed by the display device according to the embodiment.

FIG. 4 is a diagram showing how a stereoscopic image and a planar image appear in accordance with a height of a user's viewpoint.

FIG. 5 is a diagram showing a structure of a contactless switch according to the embodiment.

FIGS. 6(a) to 6(c) are diagrams showing a configuration where the contactless switch according to the present invention is applied to an input part of an elevator.

FIG. 7 is a diagram showing a configuration where the contactless switch according to the present invention is applied to an input part of a cleansing toilet seat with a warm-water spray feature.

FIG. 8(a) is a diagram showing an area of a region where, when the second optical path alteration part group forms a certain part of a different stereoscopic image, the optical path alteration parts are formed on a back surface of a light guide plate, and FIG. 8(b) is a diagram showing an area of a region where, when the second optical path alteration part group forms a certain part of a planar image, the optical path alteration parts are formed on the back surface of the light guide plate.

FIG. 9(a) is a diagram showing an area of a region where, when a stereoscopic image and a different stereoscopic image are formed at positions overlapping each other in the air, the optical path alteration parts are formed on the back surface of the light guide plate, the region corresponding to the overlapping positions in the air, and FIG. 9(b) is a diagram showing an area of a region where, when a stereoscopic image and a different stereoscopic image are formed at positions separate from each other in the air, the optical path alteration parts are formed on the back surface of the light guide plate, the region corresponding to each of the positions in the air.

FIG. 10(a) is a diagram showing a structure of the light guide plate according to a modification, and FIG. 10(b) is a cross-sectional view of an end surface of the light guide plate shown in FIG. 10(a), taken along a plane parallel to a direction from a light source toward the end surface and orthogonal to the back surface.

FIG. 11(a) is a diagram showing a structure of the light guide plate according to another modification, and FIG. 11(b) is a cross-sectional view of an end surface of the light guide plate shown in FIG. 11(a), taken along a plane parallel to a direction from the light source toward the end surface and orthogonal to the back surface.

FIG. 12 is a perspective view of a display device according to a modification of the embodiment.

FIG. 13 is a cross-sectional view of the display device according to the modification of the embodiment, showing a structure of the display device.

FIG. 14 is a plan view of the display device according to the modification of the embodiment, showing the structure of the display device.

FIG. 15 is a perspective view of an optical path alteration part included in the display device according to the modification of the embodiment, showing a structure of the optical path alteration part.

FIG. 16 is a perspective view showing an arrangement of the optical path alteration parts.

FIG. 17 is a perspective view of the display device according to the modification of the embodiment, showing how a stereoscopic image is formed by the display device.

FIG. 18 is a diagram showing another example of the image formed by the display device different from FIG. 3.

FIG. 19 is a diagram showing yet another example of the image formed by the display device different from FIG. 18.

### MODE FOR CARRYING OUT THE INVENTION

Hereinafter, an embodiment according to an aspect of the present invention (hereinafter, also referred to as “the embodiment”) will be described with reference to the drawings.

### 1. Application Example

A display device 10 according to the embodiment includes a light source 12 and a light guide plate 11. The light guide plate 11 guides light incident from the light source 12, alters an optical path of the light thus guided, and causes the light to exit from an outgoing surface so as to form a first image and a second image in the air.

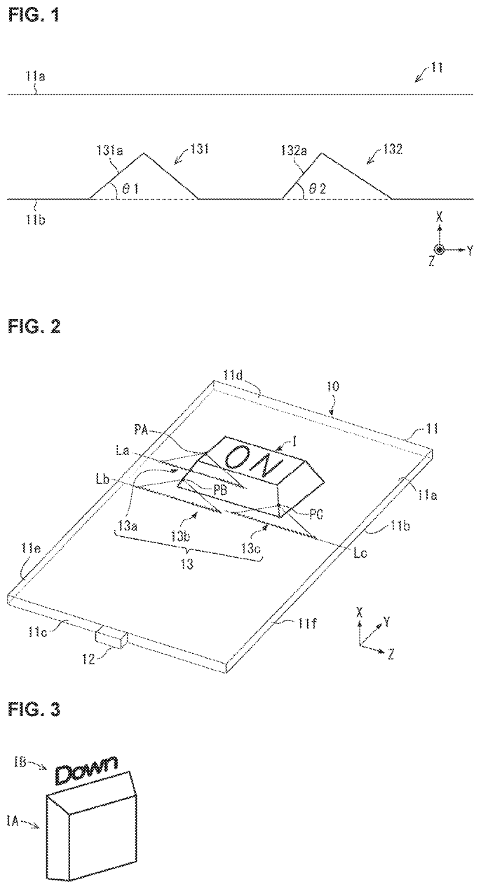

FIG. 2 is a diagram showing an example of a structure of the display device 10 according to the embodiment. FIG. 2 shows a state where the display device 10 displays a stereoscopic image I, more specifically, a button-shaped stereoscopic image I on which letters “ON” are displayed.

The light guide plate 11 has a rectangular parallelepiped shape and is made of a resin material that is transparent and relatively high in refractive index. Examples of the material of the light guide plate 11 include a polycarbonate resin, a polymethyl methacrylate resin, glass, and the like. The light guide plate 11 includes an outgoing surface 11a from which light exits, a back surface 11b opposite to the outgoing surface 11a, and end surfaces 11c, 11d, 11e, and 11f on four sides of the light guide plate 11. The end surface 11c is an incident surface where light projected from the light source 12 is incident on the light guide plate 11. The end surface 11d is a surface opposite to the end surface 11c. The end surface 11e is a surface opposite to the end surface 11f. The light guide plate 11 guides light incident from the light source 12 and causes the light to exit from the outgoing surface 11a to form an image in the air. The light source 12 is, for example, a light emitting diode (LED) light source.

On the back surface 11b of the light guide plate 11, a plurality of optical path alteration parts 13 including an optical path alteration part 13a, an optical path alteration part 13b, and an optical path alteration part 13c are provided. The optical path alteration part 13a, the optical path alteration part 13b, and the optical path alteration part 13c are provided along a line La, a line Lb, and a line Lc, respectively. Herein, the line La, the line Lb, and the line Lc are straight lines approximately parallel with a Z-axis direction. Any of the optical path alteration parts 13 are provided so as to be substantially contiguous in the Z-axis direction. In other words, the plurality of optical path alteration parts 13 are each provided along a corresponding predetermined line in a plane parallel to the outgoing surface 11a.

Light projected from the light source 12 and guided by the light guide plate 11 is incident on a position of each optical path alteration part 13 in the Z-axis direction. Each optical path alteration part 13 substantially converges the light incident on the position of the optical path alteration part 13 to a fixed point corresponding to the optical path alteration part 13. FIG. 3 specifically shows the optical path alteration part 13a, the optical path alteration part 13b, and the optical path alteration part 13c as some of the optical path alteration parts 13. FIG. 3 further shows how a plurality of rays of light exiting from each of the optical path alteration part 13a, the optical path alteration part 13b, and the optical path alteration part 13c converge in each of the optical path alteration part 13a, the optical path alteration part 13b, and the optical alteration path 13c.

Specifically, the optical path alteration part 13a corresponds to a fixed point PA on the stereoscopic image I. Light from each position of the optical path alteration part 13a converges to the fixed point PA. This makes wavefronts of the light from the optical path alteration part 13a look like wavefronts of the light emitted from the fixed point PA. The optical path alteration part 13b corresponds to a fixed point PB on the stereoscopic image I. Light from each position of the optical path alteration part 13b converges to the fixed point PB. As described above, the light from each position of any of the optical path alteration parts 13 substantially converges to the fixed point corresponding to the optical path alteration part 13. This allows any of the optical path alteration parts 13 to provide wavefronts of light as if the light is emitted from the corresponding fixed point. The fixed point differs for each optical path alteration part 13, and the stereoscopic image I recognized by the user is formed, in the air (more specifically, in the air adjacent to the outgoing surface 11a of the light guide plate 11), of a collection of the plurality of fixed points corresponding to the optical path alteration parts 13.

### 2. Configuration Example

FIG. 3 is a diagram showing an example of an image formed by the display device 10 according to the embodiment. In the example shown in FIG. 3, the display device 10 forms a button-shaped stereoscopic image IA (first image) and a planar image IB (second image) of a string “DOWN”. As described above, the display device 10 preferably forms both a stereoscopic image (three-dimensional image) and a planar image (two-dimensional image). Further, the display device 10 preferably forms the stereoscopic image IA and the planar image IB at positions separate from each other in the air. The reason will be described later.

In the display device 10 according to the embodiment, the light guide plate 11 includes a first optical path alteration part group 131 and a second optical path alteration part group 132 as the optical path alteration parts 13 on the back surface 11b opposite to the outgoing surface 11a. The first optical path alteration part group 131 alters the optical path of the light from the light source 12 to form the stereoscopic image IA. The second optical path alteration part group 132 alters the optical path of the light from the light source 12 to form the planar image IB. The first optical path alteration part group 131 and the second optical path alteration part group 132 each include a plurality of the optical path alteration parts.

FIG. 1 is a cross-sectional view of the optical path alteration parts belonging to the first optical path alteration part group 131 and the second optical path alteration part group 132, taken along a plane orthogonal to reflective surfaces 131a, 132a. The reflective surfaces 131a, 132a are surfaces of the optical path alteration parts configured to reflect the incident light to alter the optical path.

In each optical path alteration part, an angle of the reflective surface 131a or 132a with respect to the back surface 11b is referred to as an inclination angle. As shown in FIG. 1, the inclination angle of the optical path alteration parts belonging to the first optical path alteration part group 131 (hereinafter, simply referred to as the inclination angle of the first optical path alteration part group 131) is denoted by θ1. Further, the inclination angle of the optical path alteration parts belonging to the second optical path alteration part group 132 (hereinafter, simply referred to as the inclination angle of the second optical path alteration part group 132) is denoted by θ2. The inclination angle θ1 is, for example, 40°. The inclination angle θ2 is, for example, 50°.

Assume that, with the outgoing surface 11a parallel to the vertical direction, light emitted from the light source 12 is incident on a lower side of the light guide plate 11 in the vertical direction. In this case, the stereoscopic image IA formed by the first optical path alteration part group 131 is visually recognized in an angle range from an approximately front of the display device 10 to an upper side of the display device 10 in the longitudinal direction (vertical direction). On the other hand, the planar image IB formed by the second optical path alteration part group 132 is visually recognized in an angle range from the approximately front of the display device 10 to a lower side of the display device 10 in the longitudinal direction.

Further, when the outgoing surface 11a is parallel to a horizontal plane, the image formed by the first optical path alteration part group 131 is visually recognized in an angle range from the approximately front of the display device 10 to a side of the display device 10 remote from the light source 12 in the longitudinal direction. On the other hand, the image formed by the second optical path alteration part group 132 is visually recognized in an angle range from the approximately front of the display device 10 to a side of the display device 10 adjacent to the light source 12 in the longitudinal direction.

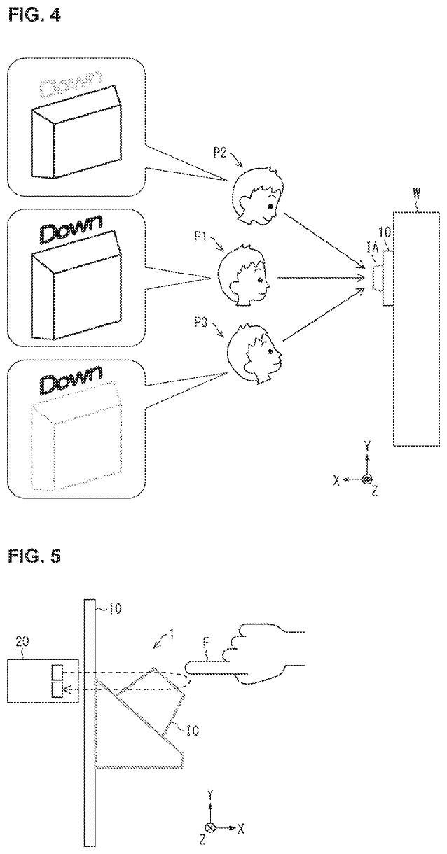

FIG. 4 is a diagram showing how the stereoscopic image IA and the planar image IB appear in accordance with a height of a user's viewpoint. In the example shown in FIG. 4, the display device 10 is provided on a vertical wall W.

In the example shown in FIG. 4, when the user's viewpoint is a viewpoint P1 having a height approximately equal to a height at which the display device 10 is provided (hereinafter, simply referred to as a height of the display device 10), the user can visually recognize both the stereoscopic image IA and the planar image IB. When the user's viewpoint is a viewpoint P2 higher than the height of the display device 10, the user cannot visually recognize the planar image IB but can visually recognize the stereoscopic image IA. Conversely, when the user's viewpoint is a viewpoint P3 lower than the height of the display device 10, the user can visually recognize the planar image IB but cannot visually recognize the stereoscopic image IA.

As described above, in the display device 10, the angle range in which the first optical path alteration part group 131 forms the stereoscopic image IA and the angle range in which the second optical path alteration part group 132 forms the planar image IB do not completely coincide with each other. Accordingly, a viewing angle at which at least either the stereoscopic image IA formed by the first optical path alteration part group 131 or the planar image IB formed by the second optical path alteration part group 132 can be visually recognized is wider than a viewing angle when all the optical path alteration parts have the same inclination angle. Therefore, the viewing angle of the display device 10 in the longitudinal direction can be made larger. For example, when the display device 10 is provided on a wall, both a tall person and a short person can visually recognize at least either the stereoscopic image IA or the planar image IB. Further, in a similar case, both a person standing and a person sitting (for example, a person using a wheelchair) can visually recognize at least either the stereoscopic image IA or the planar image IB.

The inclination angle of the first optical path alteration part group 131 and the inclination angle of the second optical path alteration part group 132 are not limited to the above example.

A difference between the inclination angle θ1 of the first optical path alteration part group 131 and the inclination angle θ2 of the second optical path alteration part group 132 is preferably equal to or greater than 10°. Such a difference between the inclination angles θ1 and θ2 allows the display device 10 to have a significantly wide viewing angle at which at least either the stereoscopic image IA or the planar image IB can be visually recognized.

Further, the inclination angle θ1 of the first optical path alteration part group 131 is preferably less than 45°, and the inclination angle θ2 of the second optical path alteration part group 132 is preferably equal to or greater than 45°. More preferably, the inclination angle θ1 of the first optical path alteration part group 131 is less than 40°, and the inclination angle θ2 of the second optical path alteration part group 132 is preferably equal to or greater than 50°. This makes the viewing angle larger toward both the side of the display device 10 adjacent to the light source 12 and the side of the display device 10 remote from the light source 12 with respect to the front of the display device 10 in the longitudinal direction.

It is further conceivable that, with the outgoing surface 11a orthogonal to the horizontal plane, light emitted from the light source 12 is incident on the upper side of the light guide plate 11. In this case, a range of the inclination angle θ1 in which the first optical path alteration part group 131 forms an image on the upper side and a range of the inclination angle θ2 in which the second optical path alteration part group 132 forms an image on the lower side are opposite to each other. Specifically, in this case, the inclination angle θ1 is preferably equal to or greater than 45°, and the inclination angle θ2 is preferably less than 45°.

The light guide plate 11 may further include an optical path alteration part group other than the first optical path alteration part group 131 and the second optical path alteration part group 132. When the light guide plate 11 includes at least three optical path alteration part groups, it is only required that a difference between the inclination angles of any two of the optical path alteration part groups be equal to or greater than 10°.

### 3. Operation Example

FIG. 5 is a diagram showing a structure of a contactless switch 1 according to the embodiment. The contactless switch 1 includes the display device 10 and a sensor 20. The display device 10 is as described above. For the sake of simplicity, FIG. 5 only shows a stereoscopic image IC having a button shape different from the stereoscopic image IA as an image formed by the display device 10.

The sensor 20 is configured to detect, in a non-contact manner, an object located at a detection point in the air. In the example shown in FIG. 5, the sensor 20 has the detection point in the vicinity of an upper surface of the button shape of the stereoscopic image IC. When the user presses the button of the stereoscopic image IC with a finger F, the sensor 20 detects the finger F (object). Specific examples of the sensor 20 include an infrared sensor, a camera sensor, a capacitive sensor, a distance sensor, and the like.

Examples of the distance sensor include a time of flight (TOF) sensor, a position sensitive detector (PSD) sensor, and the like. The TOF sensor is configured to obtain a distance from a light source to an object based on a time of flight (delay time) of light that is emitted from the light source, reflected off the object, and then reaches a light receiving unit of the sensor and the speed of light (3*10⁸ m/s). The PSD sensor is configured to detect a center-of-gravity position of a light spot.

As described above, the contactless switch 1 includes the display device 10. This allows the user to make input in accordance with an image formed by the display device 10 having a wide viewing angle.

Further, an electronic device according to the embodiment includes the contactless switch 1. Next, a description will be given of an example of the electronic device according to the embodiment.

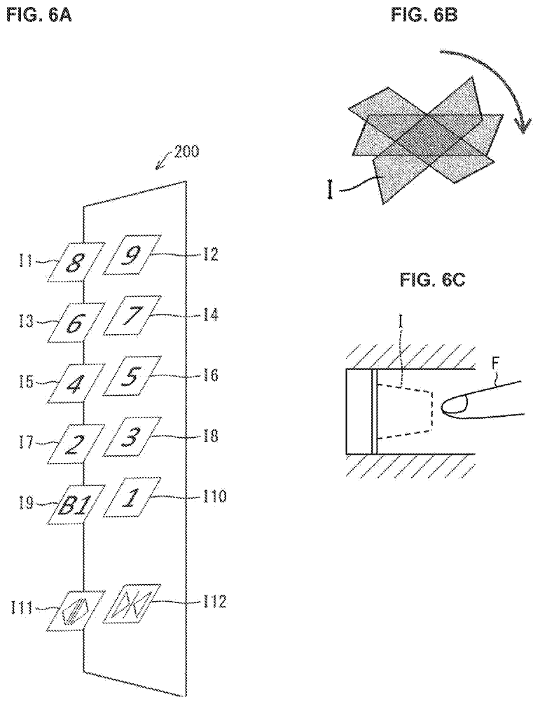

FIGS. 6(a) to 6(c) are diagrams showing a configuration where the contactless switch 1 according to the present invention is applied to an input part of an elevator. As shown in FIG. 6(a), the contactless switch 1 is applicable to, for example, an input part 200 (electronic device) of an elevator. Specifically, the input part 200 displays stereoscopic images 11 to 112. The stereoscopic images 11 to 112 are stereoscopic images on which a display (stereoscopic images 11 to 110) for receiving user input indicating a destination (floor) of the elevator and a display (stereoscopic images 111 and 112) for receiving an instruction to open or close a door of the elevator are formed. Upon receipt of user input made on any stereoscopic image I, the input part 200 changes an image forming state of the stereoscopic image I (for example, changes the color of the stereoscopic image I) and outputs an instruction corresponding to the input to a controller of the elevator. The input part 200 may display the stereoscopic image I only when a person approaches the input part 200. Further, the input part 200 may be disposed inside a wall of the elevator.

The input part 200 of the elevator may receive unintentional user input when, for example, a part of a body of the user is located at the image forming position of the stereoscopic image I due to the presence of a lot of people in the elevator, in the input part 200 of the elevator. Therefore, the input part 200 may receive user input only when, for example, a motion sensor receives a rotation operation on the stereoscopic image I. In this case, the display device 10 displays an image that prompts the user to make the rotation operation as shown in FIG. 6(b), for example. Since such a rotation operation is not usually made unless otherwise intended by the user, it is possible to prevent the input part 200 from receiving unintentional user input. As shown in FIG. 6(c), the stereoscopic image I may be displayed in a recess provided in the wall of the elevator. This causes input to be made on the stereoscopic image I only when a pointer F is inserted into the recess, which prevents the input part 200 from receiving unintentional user input.

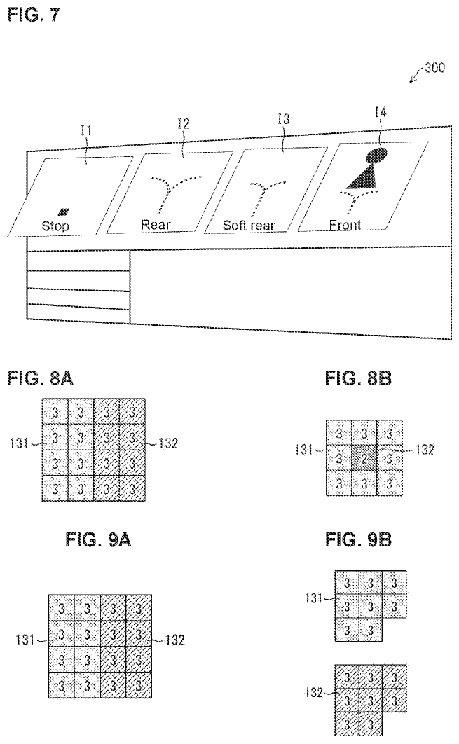

FIG. 7 is a diagram showing a configuration where the contactless switch 1 according to the present invention is applied to an input part of a cleansing toilet seat with a warm-water spray feature. As shown in FIG. 7, for example, the contactless switch 1 is applicable to an input part 300 (control panel) (electronic device) of the cleansing toilet seat with a warm-water spray feature. Specifically, the input part 300 displays stereoscopic images 11 to 14. The stereoscopic images 11 to 14 are stereoscopic images on which a display for receiving an instruction to activate or deactivate a cleansing function of the cleansing toilet seat with a warm-water spray feature is formed. Upon receipt of user input made on any stereoscopic image I, the input part 300 changes the image forming state of the stereoscopic image I (for example, changes the color of the stereoscopic image I) and outputs an instruction corresponding to the input to a controller of the cleansing toilet seat with a warm-water spray feature. Many users tend to avoid directly touching the control panel of the cleansing toilet seat with a warm-water spray feature for hygienic reasons. The input part 300 allows a user to operate the input part 300 without direct touch (physical touch). This allows the user to operate the input part 300 without paying attention to hygiene. Note that the contactless switch 1 is further applicable to other devices that preferably avoid being directly touched for hygienic reasons. For example, the contactless switch 1 is suitably applied to a numbered ticket dispenser installed in a hospital, an operation unit of a moving door that is touched by an unspecified number of people, and the like. Further, when there are a plurality of options such as a department of surgery and a department of internal medicine for such a numbered ticket dispenser installed in a hospital, it is preferable because the stereoscopic image I corresponding to each option can be displayed. Further, the contactless switch 1 is suitably applied to a cash register or a meal ticket vending machine installed in a restaurant.

The contactless switch 1 is further applicable to, for example, an input part (electronic device) of an automated teller machine (ATM), an input part (electronic device) of a credit card reader, an input part (electronic device) for use in unlocking a safe, an input part (electronic device) of a door for use in unlocking the door with a personal identification number, and the like. Herein, for a personal identification number input device in the related art, a finger is brought into physical contact with the input part to input a personal identification number. In such a case, a fingerprint or a temperature record is left in the input part. Accordingly, there is a risk that the personal identification number could be revealed to others. On the other hand, when the contactless switch 1 is used as the input part, neither a fingerprint nor a temperature record is left, which prevents the personal identification number from being revealed to others. As another example, the contactless switch 1 is applicable to a ticket vending machine installed in a station or the like.

The contactless switch 1 is further applicable to electronic devices such as a light switch of a bathroom dresser, an operation switch of a faucet, an operation switch of a range hood, an operation switch of a dishwasher, an operation switch of a refrigerator, an operation switch of a microwave oven, an operation switch of an induction heating cooktop, an operation switch of an electrolytic water generation device, an operation switch of an intercom, a light switch of a corridor, and an operation switch of a mini-component stereo system. Applying the contactless switch 1 to such switches brings about the following advantages: (i) the switch can be easily cleaned because the switch has no unevenness, (ii) an excellent design can be applied to the switch because the switch displays a stereoscopic image only when necessary (iii) the switch is kept hygienic because there is no need to touch the switch, and (iv) the switch is less prone to trouble because the switch has no moving part.

In particular, applying the contactless switch 1 allows the user to make input operation in accordance with an image formed by the display device 10 having a wide viewing angle. This allows the electronic device to offer greater convenience. It is particularly effective to apply the contactless switch 1 to an electronic device that is known to a large number of users because the switch can cope with a change in height of the viewpoint due to the height, posture, or the like of each user.

### 4. Modification

<4.1>

In the example described above, the first optical path alteration part group 131 forms the stereoscopic image IA, and the second optical path alteration part group 132 forms the planar image IB. In the display device 10 according to the embodiment, however, the second optical path alteration part group 132 may form not the planar image IB but a stereoscopic image (second image) other than the stereoscopic image IA.

Note that when the first optical path alteration part group 131 forms the stereoscopic image IA, and the second optical path alteration part group 132 forms the planar image IB, image resolution becomes high as compared with when the second optical path alteration part group 132 forms a different stereoscopic image. The reason is as follows.

FIG. 8(a) is a diagram showing an area of a region where, when the second optical path alteration part group 132 forms a certain part of a different stereoscopic image, the optical path alteration parts are formed on the back surface 11b of the light guide plate 11. FIG. 8(b) is a diagram showing an area of a region where, when the second optical path alteration part group 132 forms a certain part of the planar image IB, the optical path alteration parts are formed on the back surface 11b of the light guide plate 11. In both FIGS. 8(a) and 8(b), the first optical path alteration part group 131 forms the stereoscopic image IA.

In FIGS. 8(a) and 8(b), one square represents an area of one unit on the back surface 11b. When a stereoscopic image is formed, it is required that the optical path alteration parts be provided for each of the left and right viewing angles, which makes the area of the region where the optical path alteration parts are provided larger than when a planar image is formed. In the examples shown in FIGS. 8(a) and 8(b), a region having an area of eight units is required in order to form a certain part of the stereoscopic image. On the other hand, in the example shown in FIG. 8(b), a region having an area of one unit is required to form a certain part of the planar image.

When the second optical path alteration part group 132 forms a stereoscopic image other than the stereoscopic image IA, as shown in FIG. 8(a), the area of the region required for each of the first optical path alteration part group 131 and the second optical path alteration part group 132 to form the certain part corresponds to 16 units. On the other hand, when the second optical path alteration part group 132 forms the planar image IB, as shown in FIG. 8(b), the area of the region required for each of the first optical path alteration part group 131 and the second optical path alteration part group 132 to form the certain part corresponds to nine units.

Therefore, when the first optical path alteration part group 131 forms the stereoscopic image IA, and the second optical path alteration part group 132 forms the planar image IB, the area of the region where the optical path alteration parts necessary for forming the certain part are formed is small as compared with when the second optical path alteration part group 132 forms the stereoscopic image. As described above, the resolution of images formed by the display device 10 becomes high when the second optical path alteration part group 132 forms the planar image IB as compared with when the second optical path alteration part group 132 forms the stereoscopic image.

<4.2>

In the example described above, the stereoscopic image IA and the planar image IB are formed at positions separate from each other in the air. In the display device 10 according to the embodiment, however, the stereoscopic image IA and the planar image IB may be formed at positions overlapping each other in the air. Further, when the display device 10 forms the stereoscopic image IA and a different stereoscopic image, these stereoscopic images may be formed at positions overlapping each other in the air.

Note that image resolution becomes high when the stereoscopic image IA and the planar image IB, or the stereoscopic image IA and a different stereoscopic image are formed at positions separate from each other in the air as compared with when the stereoscopic image IA and the planar image IB, or the stereoscopic image IA and the different stereoscopic image are formed at positions overlapping each other in the air. The reason is as follows.

FIG. 9(a) is a diagram showing an area of a region where, when the stereoscopic image IA and a different stereoscopic image are formed at positions overlapping each other in the air, the optical path alteration parts are formed on the back surface 11b of the light guide plate 11, the region corresponding to the overlapping positions in the air. FIG. 9(b) is a diagram showing an area of a region where, when the stereoscopic image IA and the different stereoscopic image are formed at positions separate from each other in the air, the optical path alteration parts are formed on the back surface 11b of the light guide plate 11, the region corresponding to each of the positions in the air.

In FIGS. 9(a) and 9(b), as in FIGS. 8(a) and 8(b), one square represents an area of one unit. Further, in FIGS. 9(a) and 9(b), a region having an area of eight units is required to form the certain part of the stereoscopic image IA or the different stereoscopic image.

When the stereoscopic image IA and the different stereoscopic image are formed at positions overlapping each other in the air, as shown in FIG. 9(a), it is required that the optical path alteration parts having an area of 16 units be provided in a region of the back surface 11b corresponding to the overlapping positions in the air. As described above, when a plurality of images are formed at positions overlapping each other in the air, the optical path alteration parts that form the plurality of images are provided in a region corresponding to the overlapping positions, which makes an area of a region where the optical path alteration parts for forming each of the images can be formed smaller. As a result, when the plurality of images are formed at positions overlapping each other in the air, the resolution of the images become lower.

On the other hand, when the stereoscopic image IA and the different stereoscopic image are formed at positions separate from each other in the air, as shown in FIG. 9(b), the first optical path alteration part group 131 corresponding to a region of eight units may be provided in a region of the back surface 11b corresponding to the position in the air where the stereoscopic image IA is formed. Likewise, the second optical path alteration part group 132 corresponding to a region of eight units may be provided in a region of the back surface 11b corresponding to the position in the air where the stereoscopic image different from the stereoscopic image IA is formed. As described above, when a plurality of images are formed at positions separate from each other in the air, it is only required that the optical path alteration parts for forming each the images be provided in the region corresponding to each position in the air. Therefore, when the plurality of images are formed at positions separate from each other in the air, the resolution of the images becomes higher. A description has been given with reference to FIGS. 9(a) and 9(b) of a case where the second optical path alteration part group 132 forms a different stereoscopic image, but the same applies to a case where the second optical path alteration part group 132 forms the planar image IB.

<4.3>

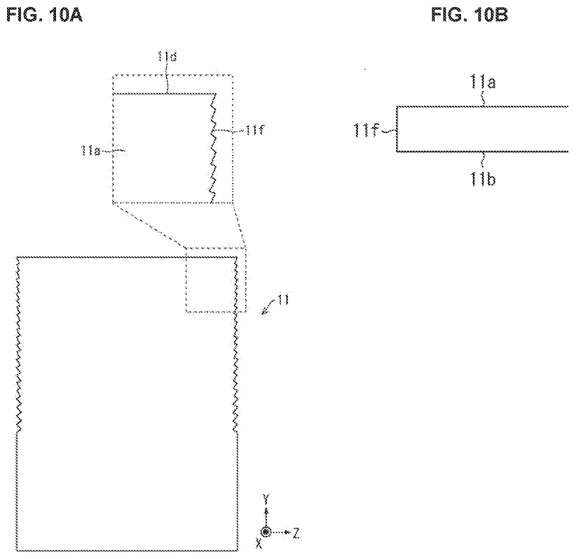

FIG. 10(a) is a diagram showing a structure of the light guide plate 11 according to a modification. FIG. 10(b) is a cross-sectional view of the end surface 11f of the light guide plate 11 shown in FIG. 10(a), taken along a plane parallel to the direction from the light source 12 toward the end surface 11f and orthogonal to the back surface 11b. The end surface 11f of the light guide plate 11 according to the modification has a saw-tooth shape. More specifically, as shown in FIGS. 10(a) and 10(b), the end surface 11f of the light guide plate 11 according to the modification has a shape in which a surface orthogonal to the light source 12 and a surface parallel to the light source 12 are alternately arranged. The same applies to the end surface 11e.

In the light guide plate 11 according to the modification, light that is emitted from the light source 12 and incident on the end surfaces 11e and 11f is largely incident on the surfaces orthogonal to the light source 12 and then exits to the outside of the light guide plate 11 as it is. This allows the light guide plate 11 according to the modification to reduce stray light. The stray light described herein refers to light that is emitted from the light source 12, reflected off the end surfaces 11e and 11f after reaching the end surfaces 11e and 11f, and then guided again in the light guide plate 11.

<4.4>

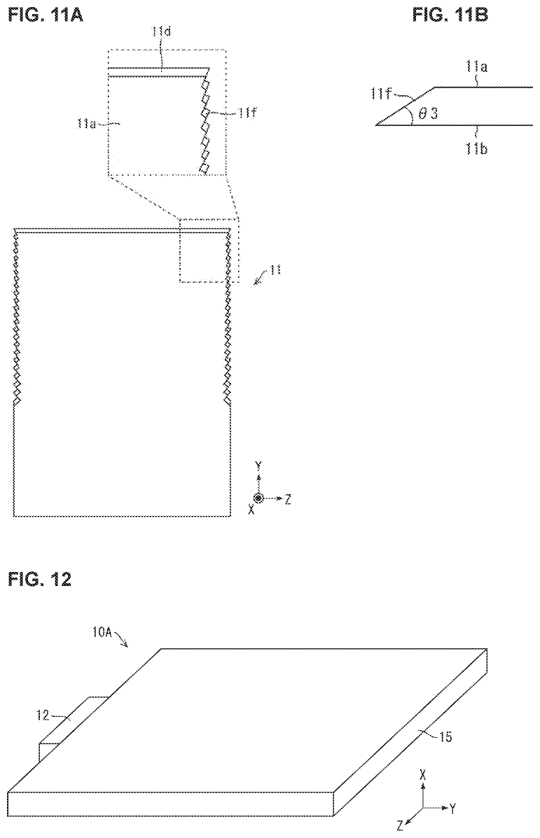

FIG. 11(a) is a diagram showing a structure of the light guide plate 11 according to another modification. FIG. 11(b) is a cross-sectional view of the end surface 11f of the light guide plate 11 shown in FIG. 11(a), taken along a plane parallel to the direction from the light source 12 toward the end surface 11f and orthogonal to the back surface 11b. The end surface 11f of the light guide plate 11 according to the modification has a saw-tooth shape as with the end surfaces 11e and 11f shown in FIG. 10(a). The same applies to the end surface 11e.

Furthermore, the end surface 11f of the light guide plate 11 according to the modification on which the light from the light source 12 is incident has a tapered shape so as to make an end portion of the surface adjacent to the outgoing surface 11a closer to the light source 12 than an end portion of the surface adjacent to the back surface 11b. In such a structure, the end surface 11f has a taper angle θ3 formed by the surface on which the light from the light source 12 is incident and the back surface 11b of the light guide plate 11. The taper angle θ3 is preferably equal to or less than 45°. Further, the end surfaces 11d and 11 e on which the light from the light source 12 is incident also have a tapered shape.

This structure causes a part of the light that is incident on the tapered surface to exit to the outside of the light guide plate 11 and causes the rest of the light to reflect toward the back surface 11b. The light reflected toward the back surface 11b largely exits from the back surface 11b to the outside of the light guide plate 11, and only a small part of the light is reflected off the back surface 11b. The light reflected off the back surface 11b is incident on the tapered surface again, and a part of the light exits to the outside of the light guide plate 11. Only light reflected again off the tapered surface becomes stray light. This allows the light guide plate 11 according to the modification to reduce stray light as compared with the light guide plate 11 shown in FIGS. 10(a) and 10(b). Note that, in the light guide plate 11 according to the modification, each of the end surfaces 11d, 11 e, and 11f may have a tapered shape with its end portion adjacent to the back surface 11b closer to the light source 12 than its end portion adjacent to the outgoing surface 11a.

<4.5>

A description will be given below of a display device 10A according to a modification of the display device 10.

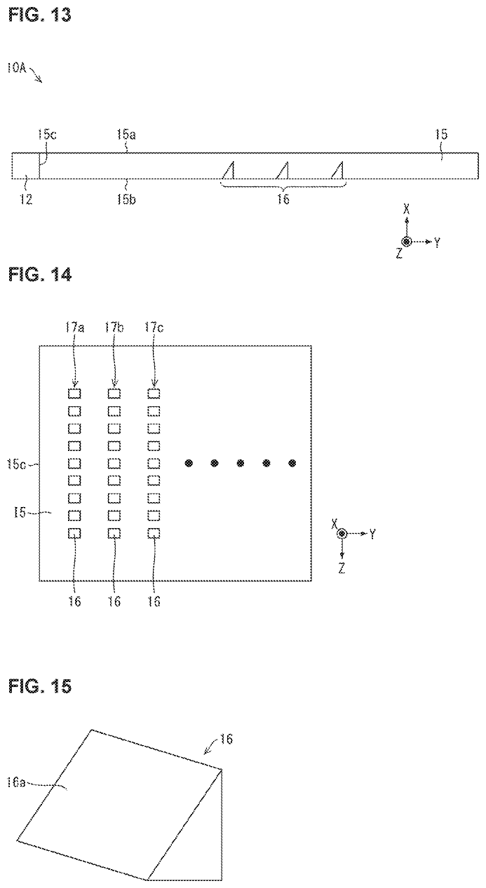

FIG. 12 is a perspective view of the display device 10A. FIG. 13 is a cross-sectional view of the display device 10A, showing a structure of the display device 10A. FIG. 14 is a plan view of the display device 10A, showing the structure of the display device 10A. FIG. 15 is a perspective view of an optical path alteration part 16 included in the display device 10A, showing a structure of the optical path alteration part 16.

As shown in FIGS. 12 and 13, the display device 10A includes a light source 12 and a light guide plate 15 (first light guide plate).

The light guide plate 15 is a member that guides light (incident light) incident from the light source 12. The light guide plate 15 is made of a resin material that is transparent and relatively high in refractive index. Examples of the material of the light guide plate 15 include a polycarbonate resin, a polymethyl methacrylate resin, and the like. According to the modification, the light guide plate 15 is made of a polymethyl methacrylate resin. As shown in FIG. 13, the light guide plate 15 includes an outgoing surface 15a (light exit surface), a back surface 15b, and an incident surface 15c.

The outgoing surface 15a is a surface from which light guided in the light guide plate 15 and altered in its optical path by the optical path alteration part 16 to be described later exits. The outgoing surface 15a serves as a front surface of the light guide plate 15. The back surface 15b is a surface that is parallel to the outgoing surface 15a and on which the optical path alteration part 16 to be described later is disposed. The incident surface 15c is a surface through which the light emitted from the light source 12 is incident on the light guide plate 15.

The light emitted from the light source 12 to incident on the light guide plate 15 through the incident surface 15c is totally reflected off the outgoing surface 15a or the back surface 15b and guided in the light guide plate 15.

As shown in FIG. 13, the optical path alteration part 16 is a member that is formed on the back surface 15b inside the light guide plate 15 and is configured to alter the optical path of the light guided in the light guide plate 15 to cause the light to exit from the outgoing surface 15a. A plurality of the optical path alteration parts 16 are provided on the back surface 15b of the light guide plate 15.

As shown in FIG. 14, the optical path alteration parts 16 are provided parallel to the incident surface 15c. As shown in FIG. 15, each optical path alteration part 16 has a triangular pyramid shape and includes a reflective surface 16a that reflects (totally reflects) incident light. As with the optical path alteration part 13 described above, the optical path alteration parts 16 include a plurality of optical path alteration part groups having their respective reflective surfaces 16a different in inclination angle from each other by at least 10°. The optical path alteration part 16 may be, for example, a recess formed in the back surface 15b of the light guide plate 15. Note that the shape of the optical path alteration part 16 is not limited to a triangular pyramid shape. As shown in FIG. 14, a plurality of optical path alteration part groups 17a, 17b, 17c . . . each including a plurality of the optical path alteration parts 16 are formed on the back surface 15b of the light guide plate 15.

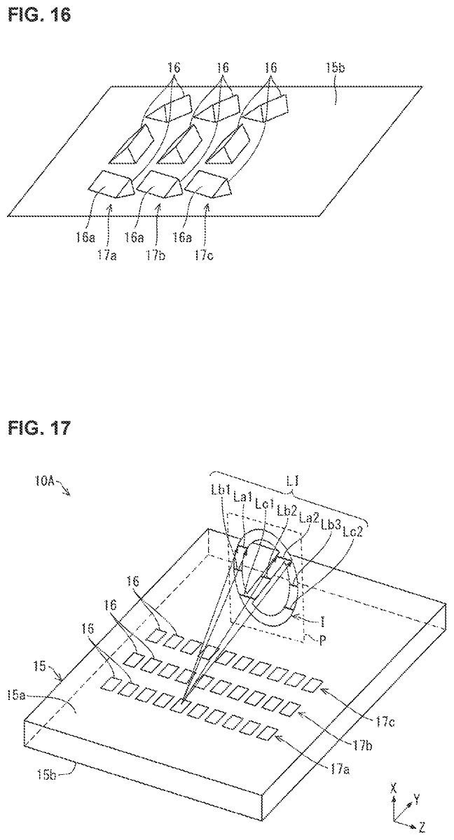

FIG. 16 is a perspective view of the optical path alteration parts 16, showing an arrangement of the optical path alteration parts 16. As shown in FIG. 16, in each of the optical path alteration part groups 17a, 17b, 17c . . . , the plurality of optical path alteration parts 16 are arranged on the back surface 15b of the light guide plate 15 so as to make the angles of the reflective surfaces 16a with respect to the incident direction of light different from each other. This causes each of the optical path alteration part groups 17a, 17b, 17c . . . to alter the optical path of the incident light to cause the light to exit from the outgoing surface 15a in various directions.

A description will be given below of a method for forming a stereoscopic image I by the display device 10A with reference to FIG. 17. Herein, a description will be given of a case where the stereoscopic image I is formed as a planar image on a stereoscopic image forming plane P perpendicular to the outgoing surface 15a of the light guide plate 15, the stereoscopic image I being formed by light altered in its optical path by the optical path alteration parts 16.

FIG. 17 is a perspective view of the display device 10A, showing how the stereoscopic image I is formed by the display device 10A. Herein, a description will be given of a case where a ring mark with a diagonal line is formed as the stereoscopic image I on the stereoscopic image forming plane P.

In the display device 10A, as shown in FIG. 17, for example, the light altered in its optical path by each optical path alteration part 16 of the optical path alteration part group 17a intersects the stereoscopic image forming plane P along a line La1 and a line La2. As a result, a line image LI that is a part of the stereoscopic image I is formed on the stereoscopic image forming plane P. The line image LI is parallel to the YZ plane. As described above, the line image LI along the lines La1 and La2 is formed by the light from a number of optical path alteration parts 16 belonging to the optical path alteration part group 17a. Note that the light for forming the image along the lines La1 and La2 may be provided by at least two optical path alteration parts 16 belonging to the optical path alteration part group 17a.

Likewise, the light altered in its optical path by each optical path alteration part 16 of the optical path alteration part group 17b intersects the stereoscopic image forming plane P along lines Lb1, Lb2, and Lb3. As a result, a line image LI that is a part of the stereoscopic image I is formed on the stereoscopic image forming plane P.

Further, the light altered in its optical path by each optical path alteration part 16 of the optical path alteration part group 17c intersects the stereoscopic image forming plane P along lines Lc1 and Lc2. As a result, a line image LI that is a part of the stereoscopic image I is formed on the stereoscopic image forming plane P.

Positions, in the X-axis direction, of the line images LI formed by the optical path alteration part groups 17a, 17b, 17c . . . are different from each other. In the display device 10A, a reduction in distance between the optical path alteration part groups 17a, 17b, 17c . . . allows a reduction in distance, in the X-axis direction, between the line images LI formed by the optical path alteration part groups 17a, 17b, 17c . . . . The display device 10A puts together the plurality of line images LI formed by the light altered in its optical path by the optical path alteration parts 16 of the optical path alteration part groups 17a, 17b, 17c . . . to form the stereoscopic image I, which is a virtually planar image, on the stereoscopic image forming plane P.

Note that the stereoscopic image forming plane P may be a plane orthogonal to the X axis, a plane orthogonal to the Y axis, or a plane orthogonal to the Z axis. Further, the stereoscopic image forming plane P may be a plane that is not orthogonal to the X axis, the Y axis, or the Z axis. Further, the stereoscopic image forming plane P may be a curved plane rather than a plane. That is, the display device 10A is capable of forming, by the optical path alteration parts 16, the stereoscopic image I on any desired plane (a plane and a curved plane) in the air. Further, a three-dimensional image can be formed of a combination of a plurality of planar images.

<4.6>

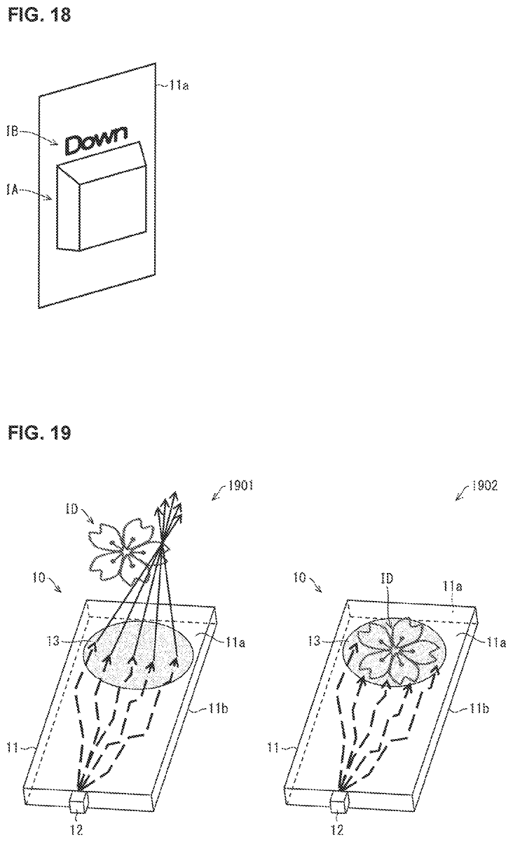

FIG. 18 is a diagram showing another example of the image formed by the display device 10 different from FIG. 3. Also in the example shown in FIG. 18, the display device 10 forms the stereoscopic image IA and the planar image IB. Note that, the example shown in FIG. 18 is different in image forming positions of the stereoscopic image IA and the planar image IB from the example shown in FIG. 3.

In the example shown in FIG. 3, the display device 10 forms the planar image IB at a position in the air different from the light guide plate 11. Alternatively, the display device 10 may form the planar image IB on the outgoing surface 11a of the light guide plate 11 as shown in FIG. 18. Such a modification also falls within the scope of in the present invention.

<4.7>

FIG. 19 is a diagram showing yet another example of the image formed by the display device 10 different from FIG. 18. According to the modification, the display device 10 forms a planar image ID by causing the light guide plate 11 to guide the light from the light source 12 and alter the optical path of the light to cause the light to exit. In FIG. 19, an example similar to the planar image IB in FIG. 3 or the like is denoted by a reference numeral 1901 for the formation of the planar image ID. Further, an example different from the planar image IB is denoted by a reference numeral 1902.

In the configuration example described above, the display device 10 forms the planar image ID outside the light guide plate 11 as denoted by the reference numeral 1901 in a similar manner as the planar image IB shown in FIG. 3 or the like. On the other hand, according to the modification, the display device 10 forms the planar image ID on the back surface 11b of the light guide plate 11, that is, the surface on which the optical path alteration parts 13 are formed as denoted by the reference numeral 1902. Such a modification also falls within the scope of in the present invention.

The present invention is not limited to any of the above-described embodiments, and various modifications may be made within the scope of the claims, and embodiments obtained by suitably combining technical means disclosed in different embodiments also fall within the technical scope of the present invention.

### SUMMARY

As described above, provided according to an aspect of the present invention is a display device including a light source, and a light guide plate configured to form a first image and a second image in the air by guiding light incident from the light source and altering an optical path of the light guided to cause the light to exit from an outgoing surface. The light guide plate includes, on a back surface opposite to the light exit surface, a first optical path alteration part group configured to alter the optical path of the light to form the first image and a second optical path alteration part group configured to alter the optical path of the light to form the second image, and a difference between an inclination angle, with respect to the back surface, of a reflective surface of the first optical path alteration part group configured to alter the optical path of the light and an inclination angle, with respect to the back surface, of a reflective surface of the second optical path alteration part group configured to alter the optical path of the light is equal to or greater than 10°.

This configuration prevents, in the display device, an angle range in which the first optical path alteration part group forms the first image and an angle range in which the second optical path alteration part group forms the second image from completely coinciding with each other in a direction in which the light from the light source is incident on the light guide plate. This makes it possible to provide a display device having a viewing angle widened to allow at least either of the first image and the second image to be visually recognized.

Further, in the display device according to an aspect of the present invention, the inclination angle, with respect to the back surface, of the reflective surface of the first optical path alteration part group configured to alter the optical path of the light is less than 45°, and the inclination angle, with respect to the back surface, of the reflective surface of the second optical path alteration part group configured to alter the optical path of the light is equal to or greater than 45°.

This configuration makes it possible to provide a display device having a viewing angle widened toward both the light source and a side opposite to the light source in the direction in which the light from the light source is incident on the light guide plate with respect to the front of the display device.

Further, in the display device according to an aspect of the present invention, one of the first image and the second image is a three-dimensional image, and the other is a two-dimensional image.

This configuration allows a reduction in area of the second optical path alteration part group. This in turn allows an increase in resolution of the first image and the second image.

Further, in the display device according to an aspect of the present invention, the first image and the second image are formed at positions separate from each other in the air.

This configuration allows an increase in resolution of the first image and the second image.

Further, a contactless switch according to an aspect of the present invention includes the display device according to any one of the above-described aspects, and a sensor configured to detect, in a non-contact manner, an object located at a detection point in the air.

This configuration allows a user to make input in accordance with an image formed by the display device having a wide viewing angle.

Further, an electronic device according to an aspect of the present invention includes the above-described contactless switch.

This configuration allows the user to operate the electronic device using the contactless switch that offers greater convenience. This makes it possible to provide an electronic device that offers greater convenience.

### DESCRIPTION OF SYMBOLS

1 contactless switch
10, 10A display device
11, 15 light guide plate
11a, 15a outgoing surface
11b, 15b back surface
12 light source
131 first optical path alteration part group
132 second optical path alteration part group
131a, 132a, 16a reflective surface sensor
200, 300 input part (electronic device)

1. A display device comprising:
a light source; and
a light guide plate configured to form a first image and a second image in air by guiding light incident from the light source and altering an optical path of the light guided to cause the light to exit from an outgoing surface, wherein
the light guide plate comprises, on a back surface opposite to the outgoing surface, a first optical path alteration part group configured to alter the optical path of the light to form the first image and a second optical path alteration part group configured to alter the optical path of the light to form the second image, and
a difference between an inclination angle, with respect to the back surface, of a reflective surface of the first optical path alteration part group configured to alter the optical path of the light and an inclination angle, with respect to the back surface, of a reflective surface of the second optical path alteration part group configured to alter the optical path of the light is equal to or greater than 10°.

2. The display device according to claim 1, wherein
an inclination angle, with respect to the back surface, of the reflective surface of the first optical path alteration part group configured to alter the optical path of the light is less than 45°, and the inclination angle, with respect to the back surface, of the reflective surface of the second optical path alteration part group configured to alter the optical path of the light is equal to or greater than 45°.

3. The display device according to claim 1, wherein
one of the first image and the second image is a three-dimensional image, and the other is a two-dimensional image.

4. The display device according to claim 1, wherein
the first image and the second image are formed at positions separate from each other in the air.

5. A contactless switch comprising:
a display device according to claim 1; and
a sensor configured to detect, in a non-contact manner, an object located at a detection point in the air.

6. An electronic device comprising a contactless switch according to claim 5.

7. The display device according to claim 2, wherein
one of the first image and the second image is a three-dimensional image, and the other is a two-dimensional image.

8. The display device according to claim 2, wherein
the first image and the second image are formed at positions separate from each other in the air.

9. The display device according to claim 3, wherein
the first image and the second image are formed at positions separate from each other in the air.

10. The display device according to claim 7, wherein
the first image and the second image are formed at positions separate from each other in the air.

11. A contactless switch comprising:
a display device according to claim 2; and
a sensor configured to detect, in a non-contact manner, an object located at a detection point in the air.

12. A contactless switch comprising:
a display device according to claim 3; and
a sensor configured to detect, in a non-contact manner, an object located at a detection point in the air.

13. A contactless switch comprising:
a display device according to claim 4; and
a sensor configured to detect, in a non-contact manner, an object located at a detection point in the air.

14. A contactless switch comprising:
a display device according to claim 8; and
a sensor configured to detect, in a non-contact manner, an object located at a detection point in the air.

15. A contactless switch comprising:
a display device according to claim 9; and
a sensor configured to detect, in a non-contact manner, an object located at a detection point in the air.

16. A contactless switch comprising:
a display device according to claim 10; and
a sensor configured to detect, in a non-contact manner, an object located at a detection point in the air.

17. An electronic device comprising a contactless switch according to claim 11.

18. An electronic device comprising a contactless switch according to claim 12.

19. An electronic device comprising a contactless switch according to claim 13.

20. An electronic device comprising a contactless switch according to claim 14.
